(19) United States
(12) Patent Application Publication
(10) Pub. No.: US 2023/0383383 A1
(43) Pub. Date: Nov. 30, 2023

(54) VEHICLE INCLUDING RECYCLABLE CAST ALUMINUM ALLOY COMPONENTS AND METHOD OF MANUFACTURING ALUMINUM ALLOY COMPONENTS FROM RECYCLED VEHICLE COMPONENTS

(71) Applicant: GM GLOBAL TECHNOLOGY OPERATIONS LLC, Detroit, MI (US)

(72) Inventors: Pan WANG, Shanghai (CN); Henry ZHAN, Shanghai (CN); Jianfeng WANG, Nanjing (CN); Lepeng ZHANG, Shanghai (CN)

(73) Assignee: GM GLOBAL TECHNOLOGY OPERATIONS LLC, Detroit, MI (US)

(21) Appl. No.: 17/873,740

(22) Filed: Jul. 26, 2022

(30) Foreign Application Priority Data
May 31, 2022 (CN) 202210606316.X

(51) Int. Cl. C22C 21/02; C22C 1/02; B62D 29/00

(52) U.S. Cl. CPC C22C 21/02; C22C 1/026; B62D 29/008

(57) ABSTRACT

A vehicle including recyclable cast aluminum alloy components. The recyclable cast aluminum alloy components include a vehicle body component and a vehicle chassis component. In combination, the recyclable cast aluminum alloy components include, by mass: silicon in an amount greater than or equal to about 6% to less than or equal to about 11%, magnesium in an amount less than or equal to about 0.5%, iron in an amount greater than or equal to about 0.15% to less than or equal to about 0.25%, manganese in an amount less than or equal to about 0.3%, and greater than or equal to about 88% aluminum. A recycled aluminum alloy component may be cast from a melt of the recyclable cast aluminum alloy components. The recyclable cast aluminum alloy components account for, by mass, greater than or equal to about 70%, about 80%, or about 90% of the recycled aluminum alloy component.

### CROSS-REFERENCE TO RELATED APPLICATIONS

This application claims the benefit and priority of Chinese Application No. 202210606316.X filed May 31, 2022. The entire disclosure of the above application is incorporated herein by reference.

### INTRODUCTION

This section provides background information related to the present disclosure which is not necessarily prior art.

The present disclosure generally relates to cast aluminum alloy components and, more particularly, to vehicles including recyclable cast aluminum alloy components.

Aluminum alloys are used in the manufacture of consumer products and component parts and may be formed into desired shapes via a variety of methods, including via die casting and permanent mold casting. In traditional casting processes, molten metal is introduced into a mold cavity and allowed to cool and solidify prior to removal of the cast part therefrom. A lubricant may be sprayed onto an interior surface of the mold cavity prior to casting, for example, to help control the temperature of the mold and to assist in removal of the cast part from the mold. In some casting processes (e.g., high pressure die casting processes), molten metal is forced into the mold cavity under high gauge pressure (e.g., at pressures of about 1,500 psi to about 25,400 psi), which may facilitate fast filling of the mold cavity and may allow for high volume production of parts having relatively thin walls (e.g., less than about 5 millimeters). In other casting processes, mold metal may be introduced into the mold cavity by gravity, by application of a relatively low gauge pressure (e.g., about 3 psi to about 50 psi), or under vacuum, which may facilitate production of relatively thick-walled (e.g., greater than about 5 millimeters) cast parts having relatively low porosity. Examples of these relatively low-pressure casting processes include permanent mold casting (e.g., low pressure die casting, counter pressure casting, and gravity casting), semi-permanent mold casting processes using sand cores, and sand casting.

Molds used for casting aluminum alloy parts are oftentimes made of steel and a casting defect known as soldering may occur during the casting process when molten aluminum sticks or solders to the interior surface of the mold cavity and remains in the cavity after removal of the cast part from the mold. To avoid soldering defects, the aluminum alloys may be formulated to include relatively high amounts of iron (e.g., greater than about 0.8% Fe by mass) or manganese (e.g., greater than about 0.5% Mn by mass). However, such high amounts of iron and/or manganese may reduce the ductility of cast aluminum alloy parts made therefrom, which may prevent such alloys from being used to manufacture certain structural component parts, such as in the automotive industry. For example, when casting aluminum alloy parts, sufficiently high ductility may be necessary to ensure that the cast parts exhibit excellent crushing or crash performance, even when the parts are designed with thin walls for reduced weight.

Recycling of aluminum alloy components is desirable for energy savings and sustainability. Compositionally closed loop recycling operations, where the composition of the input and output aluminum alloy materials is substantially the same (i.e., the same alloying elements are present in substantially the same amounts in the input and output materials) are specifically desirable because they have the potential to eliminate downcycling (and promote upcycling) of aluminum alloy components that have reached their end of life. In downcycling, mixing of a variety of different aluminum alloy components may lead to an accumulation of impurities and alloying elements in the recycled aluminum alloy material, which may limit the downstream use of the recycled material to lower purity uses. For example, aluminum alloys compositions used in high pressure die casting processes oftentimes contain relatively high amounts of iron and/or manganese to provide the aluminum alloy components made therefrom with resistance to die soldering. On the other hand, aluminum alloy compositions used in the manufacture of load-bearing structural components may be cast via relatively low-pressure casting processes and may contain relatively low amounts of iron and/or manganese to ensure that such components exhibit sufficiently high ductility. Combining aluminum alloy components with disparate compositions during recycling may prevent the resulting recycled aluminum alloy material from being reused to manufacture the same aluminum alloy components. One method of increasing upcy cling (and preventing downcy cling) of aluminum alloy components would be to analyze and separate the components by composition before melting; however, such methods may be time-consuming and expensive.

To promote upcycling of the various aluminum alloy components in a vehicle, it would be beneficial to develop a family of aluminum alloy compositions that can be used to manufacture aluminum alloy components with a variety of different chemical and mechanical properties and that exhibit sufficiently similar compositions to allow such aluminum alloy components to be combined with one another at their end of life and reused to manufacture the same aluminum alloy components.

### SUMMARY

This section provides a general summary of the disclosure and is not a comprehensive disclosure of its full scope or all of its features.

The present disclosure relates to a vehicle including greater than or equal to about 100 kilograms of recyclable cast aluminum alloy components. The recyclable cast aluminum alloy components comprise a vehicle body component and a vehicle chassis component. In combination, the recyclable cast aluminum alloy components comprise, by mass: silicon in an amount greater than or equal to about 6% to less than or equal to about 11%, magnesium in an amount less than or equal to about 0.5%, iron in an amount greater than or equal to about 0.15% to less than or equal to about 0.25%, manganese in an amount less than or equal to about 0.3%, and greater than or equal to about 87% aluminum.

In combination, the recyclable cast aluminum alloy components may further comprise, by mass: (i) chromium in an amount greater than or equal to about 0.1% to less than or equal to about 0.3% and manganese in an amount less than 0.15%, or (ii) manganese in an amount greater than or equal to about 0.2% to less than or equal to about 0.3% and strontium in an amount greater than or equal to about 100 parts per million to less than or equal to about 500 parts per million.

The vehicle body component may be cast via a high-pressure die casting process.

The vehicle body component may be cast from a first Al—Si—Mg—Fe alloy that comprises, by mass: silicon in an amount greater than or equal to about 7% to less than or equal to about 9.5%, magnesium in an amount less than or equal to about 0.25%, iron in an amount greater than or equal to about 0.15% to less than or equal to about 0.25%, and greater than or equal to about 89% aluminum.

The first Al—Si—Mg—Fe alloy may further comprise a casting agent. The casting agent may comprise, by mass: (i) chromium in an amount greater than or equal to about 0.15% to less than or equal to about 0.3% and manganese in an amount less than 0.15%, or (ii) manganese in an amount greater than or equal to about 0.2% to less than or equal to about 0.3% and strontium in an amount greater than or equal to about 300 parts per million to less than or equal to about 500 parts per million.

The vehicle body component may be a shock tower, vehicle body pillar, front end carrier, undercarriage component, floor panel, floor pan, door frame, door frame impact bar, roof reinforcement, window frame, window frame reinforcement, column reinforcement, bumper beam, firewall, instrument panel support beam, unibody structure, or a combination thereof.

The vehicle chassis component may be cast via a permanent mold casting process or a semi-permanent mold casting process.

The vehicle chassis component may be cast from a second Al—Si—Mg—Fe alloy that comprises, by mass: silicon in an amount greater than or equal to about 6.5% to less than or equal to about 7.5%, magnesium in an amount greater than or equal to about 0.25% to less than or equal to about 0.4%, iron in an amount greater than or equal to about 0.15% to less than or equal to about 0.25%, and greater than or equal to about 91% aluminum.

The second Al—Si—Mg—Fe alloy may further comprise a casting agent. The casting agent may comprise, by mass: (i) chromium in an amount greater than or equal to about 0.1% to less than or equal to about 0.2% and manganese in an amount less than 0.15%, or (ii) manganese in an amount greater than or equal to about 0.2% to less than or equal to about 0.3% and strontium in an amount greater than or equal to about 100 parts per million to less than or equal to about 200 parts per million.

The vehicle chassis component may be a vehicle frame component, subframe, wheel, engine cradle, steering component, suspension component, or a combination thereof.

The recyclable cast aluminum alloy components may further comprise a vehicle propulsion system component.

The vehicle propulsion system component may be manufactured via a high-pressure die casting process.

The vehicle propulsion system component may be cast from a third Al—Si—Mg—Fe alloy that comprises, by mass: silicon in an amount greater than or equal to about 8% to less than or equal to about 10.5%, magnesium in an amount greater than or equal to about 0.3% to less than or equal to about 0.5%, iron in an amount greater than or equal to about 0.2% to less than or equal to about 0.25%, and greater than or equal to about 88% aluminum.

The third Al—Si—Mg—Fe alloy may further comprise a casting agent. The casting agent may comprise, by mass: (i) chromium in an amount greater than or equal to about 0.2% to less than or equal to about 0.3% and manganese in an amount less than or equal to about 0.1%, or (ii) manganese in an amount greater than or equal to about 0.2% to less than or equal to about 0.3% and strontium in an amount greater than or equal to about 300 parts per million to less than or equal to about 500 parts per million.

The vehicle propulsion system component may be a motor housing, transmission case, battery housing, electrical inverter housing, electronic control module housing, or a combination thereof.

A vehicle is disclosed that includes greater than or equal to about 100 kilograms of recyclable cast aluminum alloy components. The recyclable cast aluminum alloy components comprise a vehicle body component and a vehicle chassis component.

The vehicle body component is cast via a high-pressure die casting process from a first Al—Si—Mg—Fe alloy that comprises, by mass: silicon in an amount greater than or equal to about 7% to less than or equal to about 9.5%, magnesium in an amount less than or equal to about 0.25%, iron in an amount greater than or equal to about 0.15% to less than or equal to about 0.25%, and greater than or equal to about 89% aluminum. The vehicle chassis component is cast from a second Al—Si—Mg—Fe alloy that comprises, by mass: silicon in an amount greater than or equal to about 6.5% to less than or equal to about 7.5%, magnesium in an amount greater than or equal to about 0.25% to less than or equal to about 0.4%, iron in an amount greater than or equal to about 0.15% to less than or equal to about 0.25%, and greater than or equal to about 91% aluminum.

The first Al—Si—Mg—Fe alloy may further comprise a casting agent. The casting agent may comprise, by mass: (i) chromium in an amount greater than or equal to about 0.15% to less than or equal to about 0.3% and manganese in an amount less than 0.15%, or (ii) manganese in an amount greater than or equal to about 0.2% to less than or equal to about 0.3% and strontium in an amount greater than or equal to about 300 parts per million to less than or equal to about 500 parts per million.

The second Al—Si—Mg—Fe alloy may further comprise a casting agent. The casting agent may comprise, by mass: (i) chromium in an amount greater than or equal to about 0.1% to less than or equal to about 0.2% and manganese in an amount less than 0.15%, or (ii) manganese in an amount greater than or equal to about 0.2% to less than or equal to about 0.3% and strontium in an amount greater than or equal to about 100 parts per million to less than or equal to about 200 parts per million.

The recyclable cast aluminum alloy components may further comprise a vehicle propulsion system component cast via a high-pressure die casting process from a third Al—Si—Mg—Fe alloy that comprises, by mass: silicon in an amount greater than or equal to about 8% to less than or equal to about 10.5%, magnesium in an amount greater than or equal to about 0.3% to less than or equal to about 0.5%, iron in an amount greater than or equal to about 0.2% to less than or equal to about 0.25%, a casting agent, and greater than or equal to about 88% aluminum. The casting agent may comprise, by mass, (i) chromium in an amount greater than or equal to about 0.2% to less than or equal to about 0.3% and manganese in an amount less than or equal to about 0.1%, or (ii) manganese in an amount greater than or equal to about 0.2% to less than or equal to about 0.3% and strontium in an amount greater than or equal to about 300 parts per million to less than or equal to about 500 parts per million.

A method of manufacturing an aluminum alloy component is disclosed. In the method, recyclable cast aluminum alloy components are melted to form an aluminum alloy melt comprising, by mass: silicon in an amount greater than or equal to about 6% to less than or equal to about 11%, magnesium in an amount less than or equal to about 0.5%, iron in an amount greater than or equal to about 0.15% to less than or equal to about 0.25%, manganese in an amount less than or equal to about 0.3%, and greater than or equal to about 87% aluminum. A volume of the aluminum alloy melt is cast into a desired shaped via a high-pressure die casting process, a permanent mold casting process, or a semi-permanent mold casting process. The recyclable cast aluminum alloy components account for, by mass, greater than or equal to about 70%, about 80%, or about 90% of the aluminum alloy component manufactured by the disclosed method.

In aspects, the aluminum alloy melt may further comprise, by mass: (i) chromium in an amount greater than or equal to about 0.1% to less than or equal to about 0.3% and manganese in an amount less than 0.15%, or (ii) manganese in an amount greater than or equal to about 0.2% to less than or equal to about 0.3% and strontium in an amount greater than or equal to about 100 parts per million to less than or equal to about 500 parts per million.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is a schematic perspective view of a vehicle including recyclable cast aluminum alloy components.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the FIGURES. Spatially or temporally relative terms may be intended to encompass different orientations of the device or system in use or operation in addition to the orientation depicted in the FIGURES.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent on a weight percentage (%) basis. This may include compositions or materials having, by weight, greater than 50% X, as well as those having, by weight, less than 50% X, so long as X is the single largest constituent of the composition or material based upon its overall weight.

As used herein, the term “aluminum alloy” refers to a material that comprises, by mass, greater than or equal to about 87%, greater than or equal to about 88%, greater than or equal to about 89%, or greater than or equal to about 90% aluminum (Al) and one or more other elements (referred to as “alloying” elements) selected to impart certain desirable properties to the material that are not exhibited by pure aluminum.

Aluminum alloys described herein may be represented by a sequence of chemical symbols for the base element (i.e., Al) and its major alloying elements (e.g., Si, Mg, and Fe), with the alloying elements arranged in order of decreasing mass percent (or alphabetically if percentages are similar or equal), e.g., an Al—Si—Mg—Fe alloy. Sometimes a number may precede the chemical symbol for one or more of the alloying elements. In such case, the number preceding the chemical symbol for the alloying element represents the average mass percent of that element in the alloy composition. For example, an aluminum alloy comprising, by mass, 7% silicon (Si), 0.25% iron (Fe), and the balance Al may be represented or referred to as an Al-7Si-0.25Fe alloy.

Example embodiments will now be described more fully with reference to the accompanying drawing.

The presently disclosed aluminum alloy compositions are formulated for use in the manufacture of recyclable aluminum alloy components of vehicles. A first aluminum alloy composition is formulated for use in the manufacture of vehicle body components, a second aluminum alloy composition is formulated for use in the manufacture of vehicle chassis components, and a third aluminum alloy composition is formulated for use in the manufacture of vehicle propulsion system components. A single vehicle may include a vehicle body component cast from the first aluminum alloy composition, a vehicle chassis component cast from the second aluminum alloy composition, and a vehicle propulsion system component cast from the third aluminum alloy composition. At the end of life of the vehicle, the vehicle body component, the vehicle chassis component, and the vehicle propulsion system component may be melted together to form a recycled aluminum alloy composition that can be used to manufacture via casting new vehicle body components, chassis components, and/or propulsion system components. As such, the aluminum alloy vehicle body components, vehicle chassis components, and vehicle propulsion system components respectively cast from the first, second, and third aluminum alloy compositions may be referred to herein as “recyclable.” Aluminum alloy compositions and vehicle components subsequently produced by melting together one or more of the recyclable aluminum alloy vehicle components by be referred to herein as “recycled.”

The presently disclosed aluminum alloy compositions are formulated for casting shaped aluminum alloy components and may comprise, in addition to aluminum, alloying elements of silicon (Si), magnesium (Mg), and iron (Fe), and thus may be referred to herein as Al—Si—Mg—Fe alloys. In addition, the presently disclosed aluminum alloy compositions are formulated to exhibit exceptional castability and resistance to die soldering during casting without requiring the addition of high amounts of iron or manganese. To accomplish this, the presently disclosed aluminum alloy compositions may include a casting agent. In some aspects, the casting agent may comprise or consist essentially of chromium (Cr) and optionally manganese (Mn). In other aspects, the casting agent may comprise or consist essentially of manganese (Mn) and strontium (Sr). The presently disclosed aluminum alloy compositions may include a casting agent that comprises: (i) Cr and optionally Mn, or (ii) Mn and Sr. The presently disclosed aluminum alloy compositions preferably do not include a casting agent that comprises both Cr and Sr.

The total and respective amounts of Si, Mg, Fe, and the casting agent in the Al—Si—Mg—Fe alloys are selected to promote closed-loop or near closed-loop recycling of aluminum alloy vehicle components manufactured therefrom, for example, by providing the aluminum alloy vehicle components with the ability to be combined with one another in a subsequent recycling operation and used to form new aluminum alloy vehicle components, without requiring the addition of high purity raw materials, or with minimal addition thereof, to the recycling process. In aspects where the overall amount of Mg and/or Sr in the recyclable aluminum alloy vehicle components that are melted together to form a recycled aluminum alloy composition would be greater than a desired amount for casting new vehicle body components, chassis components, and/or propulsion system components therefrom, the concentration of Mg and/or Sr in the recycled aluminum alloy composition may be reduced or eliminated prior to casting the new vehicle components. Various economical methods of reducing the concentration of Mg and/or Sr in aluminum alloy compositions are well known in the art and can be readily accomplished by persons of ordinary skill in the art without undue experimentation. As such, a relatively high concentration of Mg and/or Sr in one of the specific Al—Si—Mg—Fe alloy compositions disclosed herein will not prevent vehicle body components, chassis components, and/or propulsion system components cast therefrom from being combined with and recycled with other aluminum alloy vehicle components having relatively low concentrations of Mg and/or Sr.

The total and respective amounts of Si, Mg, and Fe in the Al—Si—Mg—Fe alloys are selected to provide the alloys with certain beneficial properties during casting and to provide aluminum alloy vehicle components cast therefrom with certain desirable mechanical and chemical properties, while minimizing the total amount of certain alloying elements therein. For example, the amount of silicon in the Al—Si—Mg—Fe alloys is selected to provide the molten alloys with suitable fluidity for casting, a relatively low melting temperature, excellent dimensional stability, and low thermal expansion. The amount of magnesium in the Al—Si—Mg—Fe alloys may be selected to provide the multipurpose aluminum alloy with mechanical strength and/or fracture toughness

The specific casting agent and the amount thereof in the Al—Si—Mg—Fe alloys are selected to provide the alloys with resistance to die soldering during casting and with a desirable combination of high ductility, high strength, fatigue resistance, and fracture toughness, while minimizing the amount of Fe, Mn, and Cr in the Al—Si—Mg—Fe alloys. The amount of iron in the Al—Si—Mg—Fe alloys is selected to limit adverse impacts on the microstructure and mechanical properties of aluminum alloy vehicle components made therefrom. The amount of the casting agent in the Al—Si—Mg—Fe alloys is selected to compensate for the relatively low amount of iron in the alloys by providing the alloys with resistance to die soldering during casting, to provide aluminum alloy vehicle components made therefrom with a desirable microstructure for improved mechanical properties, while preventing the undesirable formatting of sludge. In some aspects, aluminum alloy vehicle components cast from the presently disclosed Al—Si—Mg—Fe alloys may not exhibit die soldering when cast in a steel mold cavity at a temperature of about 705° C.

A first Al—Si—Mg—Fe alloy may be formulated for casting vehicle body components via high-pressure casting processes, e.g., high pressure die casting processes. The first Al—Si—Mg—Fe alloy may comprise, by mass, greater than or equal to about 7% or about 8% silicon; less than or equal to about 9.5% or about 9% silicon; or between about 7% to about 9.5% or about 8% to about 9% silicon. The first Al—Si—Mg—Fe alloy may comprise, by mass, greater than or equal to about 0% or about 0.1% magnesium; less than or equal to about 0.25% or about 0.15% magnesium; or between about 0% to about 0.25% or about 0.1% to about 0.15% magnesium. The first Al—Si—Mg—Fe alloy may comprise, by mass, greater than or equal to about 0.15% or about 0.2% iron; less than or equal to about 0.25% or about 0.24% iron; or between about 0.15% to about 0.25% or about 0.2% to about 0.24% iron.

In some aspects, the first Al—Si—Mg—Fe alloy may comprise a casting agent of chromium and optionally manganese. In such case, the first Al—Si—Mg—Fe alloy may comprise, by mass, greater than or equal to about 0.15% or about 0.2% chromium; less than or equal to about 0.3% or about 0.29% chromium; or between about 0.15% to about 0.3% or about 0.2% to about 0.29% chromium. In aspects where the first Al—Si—Mg—Fe alloy comprises a casting agent of chromium, the first Al—Si—Mg—Fe alloy may comprise, by mass, greater than or equal to about 0% or about 0.05% manganese; less than or equal to about 0.15% or about 0.1% manganese; or between about 0% to about 0.15% or about 0.05% to about 0.1% manganese.

In some aspects, the first Al—Si—Mg—Fe alloy may comprise a casting agent of manganese and strontium. In such case, the first Al—Si—Mg—Fe alloy may comprise, by mass, greater than or equal to about 0%, about 0.1%, or about 0.2% manganese; less than or equal to about 0.3%, about 0.2%, or about 0.1% manganese; or between about 0% to about 0.3%, about 0% to about 0.1%, or about 0.2% to about 0.3% manganese. In aspects where the first Al—Si—Mg—Fe alloy comprises a casting agent of manganese and strontium, the first Al—Si—Mg—Fe alloy may comprise, by mass, greater than or equal to about 300 parts per million or about 325 parts per million strontium; less than or equal to about 500 parts per million or about 400 parts per million strontium; or between about 300 parts per million to about 500 parts per million or about 325 parts per million to about 400 parts per million strontium.

In aspects, the first Al—Si—Mg—Fe alloy may comprise, by mass, greater than or equal to about 0% copper (Cu); less than or equal to about 0.1% copper; or between about 0% to about 0.1% copper. In aspects, the first Al—Si—Mg—Fe alloy may comprise, by mass, greater than or equal to about 0% zinc (Zn); less than or equal to about 0.1% zinc; or between about 0% to about 0.1% zinc.

The first Al—Si—Mg—Fe alloy may comprise, by mass, greater than or equal to about 89% or about 90% aluminum.

The total and respective amounts of alloying elements in the first Al—Si—Mg—Fe alloy are selected to provide vehicle body components cast therefrom with certain desirable chemical and/or mechanical properties. For example, the total and respective amounts of alloying elements in the first Al—Si—Mg—Fe alloy may be selected to provide vehicle body components cast therefrom with a desirable combination of high ductility and fracture toughness for crash performance, as well as exceptional resistance to die soldering during casting. In addition, the total and respective amounts of alloying elements in the first Al—Si—Mg—Fe alloy are selected to provide vehicle body components cast therefrom with the ability to be recycled with other aluminum alloy vehicle components described herein. More specifically, the first Al—Si—Mg—Fe alloy is formulated so that vehicle body components cast therefrom may be combined with other aluminum alloy vehicle body components, vehicle chassis components, and/or vehicle propulsion system components described herein at the end of life of the vehicle and used to form new aluminum alloy vehicle body components, vehicle chassis components, and/or vehicle propulsion system components, without requiring the addition of high purity raw materials, or with minimal addition thereof, to the recycling process.

Vehicle body components cast via high-pressure casting processes, e.g., high pressure die casting processes, from the first Al—Si—Mg—Fe alloy may exhibit a wall thickness of greater than or equal to about 0.5 millimeters to less than about 5 millimeters. During such high-pressure casting processes, a volume of the first Al—Si—Mg—Fe alloy may be cast in a mold defining the shape of the vehicle body component at a pressure in a range of about 1,500 psi to about 25,400 psi and then cooled to ambient temperature at an average cooling rate in a range of about 100 degrees Celsius per second to about 1,000 degrees Celsius per second.

Vehicle body components that may be cast from the first Al—Si—Mg—Fe alloy may be structural body components of the vehicle that are constructed and arranged to support the weight of the vehicle and absorb forces imparted to the vehicle from road shocks and in the event of a collision. Example vehicle body components that may be cast from the first Al—Si—Mg—Fe alloy via high-pressure casting processes include shock towers, vehicle body pillars (e.g., A, B, C, D, and hinge pillars), front end carriers, undercarriage components, floor panels, floor pans, door frames and impact bars, roof reinforcements, window frames and reinforcements, column reinforcements, bumper beams, firewalls, cross car beams (instrument panel support beams), unibody structures, and combinations thereof. One or more of such vehicle body components may be included in the vehicle body-in-white. In some aspects, one of more vehicle body components may be manufactured together in a single casting process and may be of unitary one-piece construction. Such unitary structures may be referred to as megacastings or gigacastings.

A second Al—Si—Mg—Fe alloy may be formulated for casting vehicle chassis components via relatively low-pressure casting processes, including permanent mold casting, semi-permanent mold casting, and sand casting. Examples of permanent mold casting processes include low pressure die casting, counter pressure casting, and gravity casting. In semi-permanent mold casting processes, sand cores may be used within the mold to form internal cavities in and/or provide certain details (e.g., undercuts and/or negative draft) to the cast component.

The second Al—Si—Mg—Fe alloy may comprise, by mass, greater than or equal to about 6.5% or about 6.8% silicon; less than or equal to about 7.5% or about 7.2% silicon; or between about 6.5% to about 7.5% or about 6.8% to about 7.2% silicon. The second Al—Si—Mg—Fe alloy may comprise, by mass, greater than or equal to about 0.25% or about 0.3% magnesium; less than or equal to about 0.4% or about 0.35% magnesium; or between about 0.25% to about 0.4% or about 0.3% to about 0.35% magnesium. The second Al—Si—Mg—Fe alloy may comprise, by mass, greater than or equal to about 0.15% or about 0.2% iron; less than or equal to about 0.25% or about 0.24% iron; or between about 0.15% to about 0.25% or about 0.2% to about 0.24% iron.

In some aspects, the second Al—Si—Mg—Fe alloy may comprise a casting agent of chromium and optionally manganese. In such case, the second Al—Si—Mg—Fe alloy may comprise, by mass, greater than or equal to about 0.1% chromium; less than or equal to about 0.2% chromium; or between about 0.1% to about 0.2% chromium. In aspects where the second Al—Si—Mg—Fe alloy comprises a casting agent of chromium, the second Al—Si—Mg—Fe alloy may comprise, by mass, greater than or equal to about 0% manganese; less than or equal to about 0.15% manganese; or between about 0% to about 0.15% manganese.

In some aspects, the second Al—Si—Mg—Fe alloy may comprise a casting agent of manganese and strontium. In such case, the second Al—Si—Mg—Fe alloy may comprise, by mass, greater than or equal to about 0.2% manganese; less than or equal to about 0.3% manganese; or between about 0.2% to about 0.3% manganese. In aspects where the second Al—Si—Mg—Fe alloy comprises a casting agent of manganese and strontium, the second Al—Si—Mg—Fe alloy may comprise, by mass, greater than or equal to about 100 parts per million strontium; less than or equal to about 200 parts per million strontium; or between about 100 parts per million to about 200 parts per million strontium.

In aspects, the second Al—Si—Mg—Fe alloy may comprise, by mass, greater than or equal to about 0% copper (Cu); less than or equal to about 0.1% copper; or between about 0% to about 0.1% copper. In aspects, the second Al—Si—Mg—Fe alloy may comprise, by mass, greater than or equal to about 0% zinc (Zn); less than or equal to about 0.1% zinc; or between about 0% to about 0.1% zinc.

The second Al—Si—Mg—Fe alloy may comprise, by mass, greater than or equal to about 90% or about 91% aluminum.

The total and respective amounts of alloying elements in the second Al—Si—Mg—Fe alloy are selected to provide vehicle chassis components cast therefrom with certain desirable chemical and/or mechanical properties. For example, the total and respective amounts of alloying elements in the second Al—Si—Mg—Fe alloy may be selected to provide vehicle chassis components cast therefrom with a desirable combination of high fatigue resistance and exceptional resistance to die soldering during casting. In addition, the total and respective amounts of alloying elements in the second Al—Si—Mg—Fe alloy may be selected to provide vehicle chassis components cast therefrom with the ability to be recycled with the other aluminum alloy vehicle components described herein in closed-loop or near closed-loop recycling processes.

Vehicle chassis components cast via relatively low-pressure casting processes (e.g., permanent mold casting, semi-permanent mold casting, or sand casting) from the second Al—Si—Mg—Fe alloy may exhibit a wall thickness of greater than 5 millimeters to less than or equal to about 10 millimeters. During such casting processes, a volume of the second Al—Si—Mg—Fe alloy may be cast in a mold defining the shape of the vehicle chassis component at a pressure of less than or equal to about 50 psi and then cooled to ambient temperature at an average cooling rate of less than or equal to about 10 degrees Celsius per second.

Examples of vehicle chassis components that may be cast from the second Al—Si—Mg—Fe alloy via permanent mold casting, semi-permanent mold casting, or sand casting include vehicle frame components (e.g., crossmembers, longitudinal beams, and side rails), subframes, wheels, engine cradles, steering and suspension components (steering knuckles, suspension strut domes, suspension links, control arms, axles, hinge bearings, strut towers, strut bars, tie bars, and/or stabilizer bars), and combinations thereof.

A third Al—Si—Mg—Fe alloy may be formulated for casting vehicle propulsion system components via high-pressure casting processes, e.g., high pressure die casting processes. The third Al—Si—Mg—Fe alloy may comprise, by mass, greater than or equal to about 8% or about 8.5% silicon; less than or equal to about 10.5% or about 10% silicon; or between about 8% to about 10.5% or about 8.5% to about 10% silicon. The third Al—Si—Mg—Fe alloy may comprise, by mass, greater than or equal to about 0.3% or about 0.35% magnesium; less than or equal to about 0.5% or about 0.45% magnesium; or between about 0.3% to about 0.5% or about 0.35% to about 0.45% magnesium. The third Al—Si—Mg—Fe alloy may comprise, by mass, greater than or equal to about 0.2% iron; less than or equal to about 0.25% iron; or between about 0.2% to about 0.25% iron.

In some aspects, the third Al—Si—Mg—Fe alloy may comprise a casting agent of chromium and optionally manganese. In such case, the third Al—Si—Mg—Fe alloy may comprise, by mass, greater than or equal to about 0.2% chromium; less than or equal to about 0.3% chromium; or between about 0.2% to about 0.3% chromium. In aspects where the third Al—Si—Mg—Fe alloy comprises a casting agent of chromium, the third Al—Si—Mg—Fe alloy may comprise, by mass, greater than or equal to about 0% manganese; less than or equal to about 0.1% manganese; or between about 0% to about 0.1% manganese.

In some aspects, the third Al—Si—Mg—Fe alloy may comprise a casting agent of manganese and strontium. In such case, the third Al—Si—Mg—Fe alloy may comprise, by mass, greater than or equal to about 0.2% manganese; less than or equal to about 0.3% manganese; or between about 0.2% to about 0.3% manganese. In aspects where the third Al—Si—Mg—Fe alloy comprises a casting agent of manganese and strontium, the third Al—Si—Mg—Fe alloy may comprise, by mass, greater than or equal to about 300 parts per million or about 325 parts per million strontium; less than or equal to about 500 parts per million or about 400 parts per million strontium; or between about 300 parts per million to about 500 parts per million or about 325 parts per million to about 400 parts per million strontium.

In aspects, the third Al—Si—Mg—Fe alloy may comprise, by mass, greater than or equal to about 0% copper (Cu); less than or equal to about 0.2% copper; or between about 0% to about 0.2% copper. In aspects, the third Al—Si—Mg—Fe alloy may comprise, by mass, greater than or equal to about 0% zinc (Zn); less than or equal to about 0.2% zinc; or between about 0% to about 0.2% zinc.

The third Al—Si—Mg—Fe alloy may comprise, by mass, greater than or equal to about 88%, about 89%, or about 90% aluminum.

The total and respective amounts of alloying elements in the third Al—Si—Mg—Fe alloy are selected to provide vehicle propulsion system components cast therefrom with certain desirable chemical and/or mechanical properties. For example, the total and respective amounts of alloying elements in the third Al—Si—Mg—Fe alloy may be selected to provide vehicle propulsion system components cast therefrom with a desirable combination of exceptional castability and resistance to die soldering during casting. In addition, the total and respective amounts of alloying elements in the third Al—Si—Mg—Fe alloy may be selected to provide vehicle propulsion system components cast therefrom with the ability to be recycled with the other aluminum alloy vehicle components described herein in closed-loop or near closed-loop recycling processes.

Vehicle propulsion system components cast via high-pressure casting processes, e.g., high pressure die casting processes, from the third Al—Si—Mg—Fe alloy may exhibit a wall thickness of greater than or equal to about 0.5 millimeters to less than about 5 millimeters. During such high-pressure casting processes, a volume of the third Al—Si—Mg—Fe alloy may be cast in a mold defining the shape of the vehicle propulsion system component at a pressure in a range of about 1,500 psi to about 25,400 psi and then cooled to ambient temperature at an average cooling rate in a range of about 100 degrees Celsius per second to about 1,000 degrees Celsius per second.

Examples of vehicle propulsion system components that may be cast from the third Al—Si—Mg—Fe alloy via high-pressure casting processes include transmission housings and cases, engine and motor housings, engine and motor covers, battery housings, electrical inverter housing, electronic control module housing, and combinations thereof.

Additional elements not intentionally introduced into the composition of the presently disclosed Al—Si—Mg—Fe alloys nonetheless may be inherently present in the alloys in relatively small amounts, for example, less than 0.1%, preferably less than 0.05%, and more preferably less than 0.01% by weight of the Al—Si—Mg—Fe alloys. Such elements may be present, for example, as impurities in the raw or scrap materials used to prepare the Al—Si—Mg—Fe alloys. In embodiments where the Al—Si—Mg—Fe alloys are referred to as comprising one or more alloying elements (e.g., one or more of Si, Mg, Fe, Mn, Cr, Sr, Cu, and/or Zn) and aluminum as balance, the term “as balance” does not exclude the presence of additional elements not intentionally introduced into the composition of the Al—Si—Mg—Fe alloys but nonetheless inherently present in the alloys in relatively small amounts, e.g., as impurities.

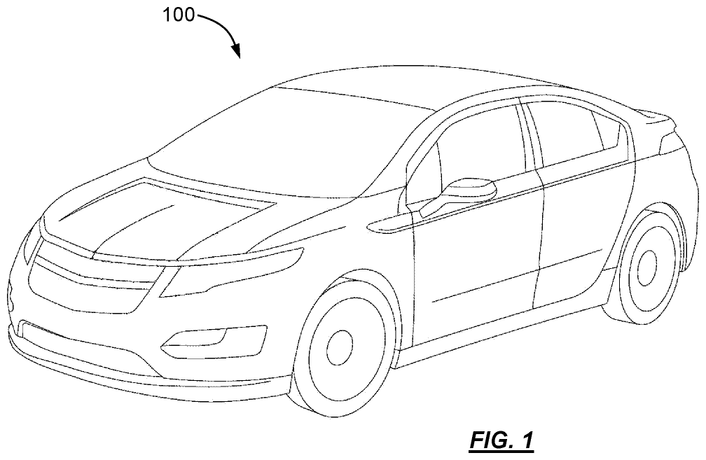

Referring now to FIG. 1, a vehicle 100, e.g., an automotive passenger vehicle, may include one or more recyclable aluminum alloy components cast from the presently disclosed Al—Si—Mg—Fe alloys. For example, the vehicle 100 may include one or more vehicle body components cast from the first Al—Si—Mg—Fe alloy, one or more vehicle chassis components cast from the second Al—Si—Mg—Fe alloy, and/or one or more vehicle propulsion system components cast from the third Al—Si—Mg—Fe alloy. The vehicle 100 may comprise greater than or equal to about 100 kilograms, about 150 kilograms, or about 200 kilograms of such recyclable aluminum alloy components.

In some aspects, the vehicle 100 may include at least one vehicle body component cast from the first Al—Si—Mg—Fe alloy, at least one vehicle chassis component cast from the second Al—Si—Mg—Fe alloy, and at least one vehicle propulsion system component cast from the third Al—Si—Mg—Fe alloy. In such case, the at least one vehicle body component may account for, by mass, greater than or equal to about 5% to less than or equal to about 60% of the recyclable aluminum alloy components included in the vehicle 100; the at least one vehicle chassis component may account for, by mass, greater than or equal to about 10% to less than or equal to about 80% of the recyclable aluminum alloy components included in the vehicle 100; and the at least one vehicle propulsion system component may account for, by mass, greater than or equal to about 0% to less than or equal to about 20% of the recyclable aluminum alloy components included in the vehicle 100.

In some aspects, the at least one vehicle body component may account for, by mass, greater than or equal to about 20% to less than or equal to about 30% or greater than or equal to about 50% to less than or equal to about 60% of the recyclable aluminum alloy components included in the vehicle 100; the at least one vehicle chassis component may account for, by mass, greater than or equal to about 20% to less than or equal to about 30% or greater than or equal to about 50% to less than or equal to about 60% of the recyclable aluminum alloy components included in the vehicle 100; and the at least one vehicle propulsion system component may account for, by mass, greater than or equal to about 10% to less than or equal to about 20% of the recyclable aluminum alloy components included in the vehicle 100.

In combination, the recyclable aluminum alloy components included in the vehicle 100 may comprise, by mass, greater than or equal to about 6.5% or about 7% silicon; less than or equal to about 10.5% or about 9% silicon; or between about 6.5% to about 10.5% or about 7% to about 9% silicon. The recyclable aluminum alloy components included in the vehicle 100 may comprise, by mass, greater than or equal to about 0%, about 0.05%, or about 0.1% magnesium; less than or equal to about 0.5%, about 0.4% or about 0.35% magnesium; or between about 0% to about 0.5%, about 0.05% to about 0.4%, or about 0.1% to about 0.35% magnesium. The recyclable aluminum alloy components included in the vehicle 100 may comprise, by mass, greater than or equal to about 0.15% or about 0.2% iron; less than or equal to about 0.25% or about 0.24% iron; or between about 0.15% to about 0.25% or between about 0.2% to about 0.24% iron.

In some aspects, the recyclable aluminum alloy components included in the vehicle 100 may comprise a casting agent of chromium and optionally manganese. In such case, in combination, the recyclable aluminum alloy components may comprise, by mass, greater than or equal to about 0.1% or about 0.12% chromium; less than or equal to about 0.3% or about 0.28% chromium; or between about 0.% to about 0.3% or between about 0.12% to about 0.28% chromium. In aspects where the recyclable aluminum alloy components comprise a casting agent of chromium, the recyclable aluminum alloy components may comprise, by mass, greater than or equal to about 0% manganese; less than or equal to about 0.15% or about 0.13% manganese; or between about 0% to about 0.15 or between about 0% to about 0.13% manganese.

In some aspects, the recyclable aluminum alloy components included in the vehicle 100 may comprise a casting agent of manganese and strontium. In such case, the recyclable aluminum alloy components may comprise, by mass, greater than or equal to about 0.2% manganese; less than or equal to about 0.3% manganese; or between about 0.2% to about 0.3% manganese. In aspects where the recyclable aluminum alloy components comprise a casting agent of manganese and strontium, the recyclable aluminum alloy components may comprise, by mass, greater than or equal to about 100 parts per million or about 150 parts per million strontium; less than or equal to about 500 parts per million or about 400 parts per million strontium; or between about 100 parts per million to about 500 parts per million or between about 150 parts per million to about 400 parts per million strontium.

In aspects, the recyclable aluminum alloy components included in the vehicle 100 may comprise, by mass, greater than or equal to about 0% copper (Cu); less than or equal to about 0.2% copper; or between about 0% to about 0.2% copper. In aspects, the recyclable aluminum alloy components included in the vehicle 100 may comprise, by mass, greater than or equal to about 0% zinc (Zn); less than or equal to about 0.2% zinc; or between about 0% to about 0.2% zinc.

The recyclable aluminum alloy components included in the vehicle 100 may comprise, by mass, greater than or equal to about 88%, about 89%, or about 90% aluminum.

### EXAMPLES

The following examples illustrate how the presently disclosed Al—Si—Mg—Fe alloys can be used to promote closed-loop or near closed-loop recycling of aluminum alloy vehicle components manufactured therefrom.

An assembled automotive vehicle may include multiple cast aluminum alloy components with a combined mass of about 108 kilograms (kg), as shown in Table 1 below.

TABLE 1

| Vehicle Component | Component Type | Mass (kg) |
|---|---|---|
| housing for power electronics | propulsion system | 10 |
| housing for electric motor | propulsion system | 10 |
| subframe | chassis | 15 |
| steering knuckle and control arm | chassis | 12 |
| shock tower | body | 6 |
| hinge pillar | body | 5 |
| unibody structure | body | 50 |
| | Total: | 108 |

A380 and A360 are commercial aluminum alloys used for casting various components of automotive vehicles, including vehicle propulsion system components. A356.2 is a commercial aluminum alloy used for casting various components of automotive vehicles, including vehicle chassis components. A365 is a commercial aluminum alloy used for casting various components of automotive vehicles, including vehicle body components. The approximate compositions of commercial alloys A380, A360, A356.2, and A365 are shown in Table 2 below, where aluminum makes up the balance of the compositions.

TABLE 2

| | Composition (%) | | | | |
|---|---|---|---|---|---|
| Alloy | Si | Cu | Mg | Fe | Mn |
| A380 | 9.0 | 3.0 | | 0.8 | |
| A360 | 10.0 | | 0.5 | 1.0 | 0.35 |
| A356.2 | 7 | | 0.3 | 0.12 | |
| A365 | 10 | | 0.3 | 0.15 | 0.5 |

If the vehicle propulsion system components listed in Table 1 were cast from commercial alloy A380, the vehicle chassis components listed in Table 1 were cast from commercial alloy A356.2, and the vehicle body components listed in Table 1 were cast from commercial alloy A365, the overall composition of the vehicle components would comprise, by mass, about 9.5% Si, about 0.4% Mg, about 0.37% Mn, about 0.33% Fe, about 0.55% Cu, and the balance Al. If these vehicle components were combined with one another in a single recycling operation, the relatively high amounts of Mn, Fe, and Cu in the recycled aluminum alloy material would prevent the recycled material from being used to formulate new aluminum alloy compositions for casting new vehicle body components and/or new vehicle chassis components. The relatively high amounts of Mn, Fe, and Cu in the recycled aluminum alloy material would lead to downcycling of the original aluminum alloy vehicle components.

Table 3 below lists examples of a first Al—Si—Mg—Fe alloy including a casting agent of Cr and optionally Mn that may be used to cast recyclable vehicle body components (Body-1), a second Al—Si—Mg—Fe alloy including a casting agent of Cr and optionally Mn that may be used to cast recyclable vehicle chassis components (Chassis-1), and a third Al—Si—Mg—Fe alloy including a casting agent of Cr and optionally Mn that may be used to cast recyclable vehicle propulsion system components (Propulsion-1).

TABLE 3

| | Composition (%) | | | | | |
|---|---|---|---|---|---|---|
| Alloy | Si | Mg | Cr | Mn | Fe | Sr |
| Body-1 | 8-9 | 0-0.1 | 0.15-0.3 | 0-0.1 | 0.2-0.25 | — |
| Chassis-1 | 6.5-7.5 | 0.25-0.35 | 0.1-0.2 | 0-0.15 | 0.2-0.25 | — |
| Propulsion-1 | 9-10 | 0.4-0.5 | 0.15-0.3 | 0-0.1 | 0.2-0.25 | — |

If the vehicle propulsion system components listed in Table 1 were cast from the recyclable Propulsion-1 alloy shown in Table 3, the vehicle chassis components listed in Table 1 were cast from the recyclable Chassis-1 alloy shown in Table 3, and the vehicle body components listed in Table 1 were cast from the recyclable Body-1 alloy shown in Table 3, the overall composition of the recyclable vehicle components would comprise, by mass, about 7.8-8.9% Si, about 0.12-0.25% Mg, about 0.14-0.28% Cr, about 0-0.11% Mn, and about 0.2-0.25% Fe. And, if the recyclable vehicle components were combined with one another in a single recycling operation, about 100% of the recycled aluminum alloy composition could be used to formulate an alloy having the composition of the recyclable Propulsion-1 alloy listed in Table 3. As such, about 100% of the recycled aluminum alloy composition could be used to cast new recyclable vehicle propulsion system components. In addition, if the recyclable vehicle components were combined with one another in a single recycling operation, about 100% of the recycled aluminum alloy composition could be used to formulate an alloy having the composition of the recyclable Body-1 alloy listed in Table 3. As such, about 100% of the recycled aluminum alloy composition could be used to cast new recyclable vehicle body components. Furthermore, if the recyclable vehicle components were combined with one another in a single recycling operation, about 70% of the recycled aluminum alloy composition could be used to formulate an alloy having the composition of the recyclable Chassis-1 alloy listed in Table 3. As such, about 70% of the recycled aluminum alloy composition could be used to cast new recyclable vehicle chassis components.

Table 4 below lists examples of a first Al—Si—Mg—Fe alloy including a casting agent of Mn and Sr that may be used to cast recyclable vehicle body components (Body-2), a second Al—Si—Mg—Fe alloy including a casting agent of Mn and Sr that may be used to cast recyclable vehicle chassis components (Chassis-2), and a third Al—Si—Mg—Fe alloy including a casting agent of Mn and Sr that may be used to cast recyclable vehicle propulsion system components (Propulsion-2).

TABLE 4

| | Composition (%) | | | | | (ppm) |
|---|---|---|---|---|---|---|
| Alloy | Si | Mg | Cr | Mn | Fe | Sr |
| Body-2 | 8-9 | 0-0.1 | — | 0.2-0.3 | 0.2-0.25 | 250-400 |
| Chassis-2 | 6.5-7.5 | 0.25-0.4 | — | 0.2-0.3 | 0.2-0.25 | 100-200 |
| Propulsion-2 | 9-10.5 | 0.3-0.5 | — | 0.2-0.3 | 0.2-0.25 | 250-400 |

If the vehicle propulsion system components listed in Table 1 were cast from the recyclable Propulsion-2 alloy shown in Table 4, the vehicle chassis components listed in Table 1 were cast from the recyclable Chassis-2 alloy shown in Table 4, and the vehicle body components listed in Table 1 were cast from the recyclable Body-2 alloy shown in Table 4, the overall composition of the recyclable vehicle components would comprise, by mass, about 7.8-8.9% Si, about 0.12-0.25% Mg, about 0.2-0.3% Mn, about 0.2-0.25% Fe, and about 212-350 ppm Sr. And, if the recyclable vehicle components were combined with one another in a single recycling operation, about 100% of the recycled aluminum alloy composition could be used to formulate an alloy having the composition of the recyclable Propulsion-2 alloy listed in Table 4. As such, about 100% of the recycled aluminum alloy composition could be used to cast new recyclable vehicle propulsion system components. In addition, if the recyclable vehicle components were combined with one another in a single recycling operation, about 100% of the recycled aluminum alloy composition could be used to formulate an alloy having the composition of the recyclable Body-2 alloy listed in Table 4. As such, about 100% of the recycled aluminum alloy composition could be used to cast new recyclable vehicle body components. Furthermore, if the recyclable vehicle components were combined with one another in a single recycling operation, about 84% of the recycled aluminum alloy composition could be used to formulate an alloy having the composition of the recyclable Chassis-2 alloy listed in Table 4. As such, about 84% of the recycled aluminum alloy composition could be used to cast new recyclable vehicle chassis components.

The foregoing description of the embodiments has been provided for purposes of illustration and description. It is not intended to be exhaustive or to limit the disclosure. Individual elements or features of a particular embodiment are generally not limited to that embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A vehicle including recyclable cast aluminum alloy components, the recyclable cast aluminum alloy components comprising a vehicle body component and a vehicle chassis component, wherein, in combination, the recyclable cast aluminum alloy components comprise, by mass:
silicon in an amount greater than or equal to about 6% to less than or equal to about 11%;
magnesium in an amount less than or equal to about 0.5%;
iron in an amount greater than or equal to about 0.15% to less than or equal to about 0.25%;
manganese in an amount less than or equal to about 0.3%; and
greater than or equal to about 87% aluminum,
wherein the vehicle body component comprises a first Al—Si—Mg—Fe alloy that comprises, by mass:
silicon in an amount greater than or equal to 8% and less than or equal to about 9.5%;
magnesium in an amount less than or equal to 0.15%;
iron in an amount greater than or equal to about 0.15% to less than or equal to about 0.25%; and
greater than or equal to about 89% aluminum, and
wherein the vehicle chassis component comprises a second Al—Si—Mg—Fe alloy that comprises, by mass:
silicon in an amount greater than or equal to about 6.5% to less than or equal to 7.5%;
magnesium in an amount greater than or equal to about 0.25% to less than or equal to about 0.4%;
iron in an amount greater than or equal to about 0.15% to less than or equal to about 0.25%; and
greater than or equal to about 91% aluminum, and
wherein the composition of the first Al—Si—Mg—Fe alloy is different from that of the second Al—Si—Mg—Fe alloy.

2. The vehicle of claim 1, wherein, in combination, the recyclable cast aluminum alloy components further comprise, by mass:
(i) chromium in an amount greater than or equal to about 0.1% to less than or equal to about 0.3% and manganese in an amount less than 0.15%, or
(ii) manganese in an amount greater than or equal to about 0.2% to less than or equal to about 0.3% and strontium in an amount greater than or equal to about 100 parts per million to less than or equal to about 500 parts per million.

3. The vehicle of claim 1, wherein the vehicle body component is cast via a high-pressure die casting process.

4. (canceled)

5. The vehicle of claim 1, wherein the first Al—Si—Mg—Fe alloy further comprises a casting agent, and wherein the casting agent comprises, by mass:
(i) chromium in an amount greater than or equal to about 0.15% to less than or equal to about 0.3% and manganese in an amount less than 0.15%, or
(ii) manganese in an amount greater than or equal to about 0.2% to less than or equal to about 0.3% and strontium in an amount greater than or equal to about 300 parts per million to less than or equal to about 500 parts per million.

6. The vehicle of claim 1, wherein the vehicle body component is a shock tower, vehicle body pillar, front end carrier, undercarriage component, floor panel, floor pan, door frame, door frame impact bar, roof reinforcement, window frame, window frame reinforcement, column reinforcement, bumper beam, firewall, instrument panel support beam, unibody structure, or a combination thereof.

7. The vehicle of claim 1, wherein the vehicle chassis component is cast via a permanent mold casting process or a semi-permanent mold casting process.

8. (canceled)

9. The vehicle of claim 1, wherein the second Al—Si—Mg—Fe alloy further comprises a casting agent, and wherein the casting agent comprises, by mass:
(i) chromium in an amount greater than or equal to about 0.1% to less than or equal to about 0.2% and manganese in an amount less than 0.15%, or
(ii) manganese in an amount greater than or equal to about 0.2% to less than or equal to about 0.3% and strontium in an amount greater than or equal to about 100 parts per million to less than or equal to about 200 parts per million.

10. The vehicle of claim 1, wherein the vehicle chassis component is a vehicle frame component, subframe, wheel, engine cradle, steering component, suspension component, or a combination thereof.

11. The vehicle of claim 1, wherein the recyclable cast aluminum alloy components further comprise a vehicle propulsion system component, wherein the vehicle propulsion system component comprises a third Al—Si—Mg—Fe alloy that comprises, by mass:
silicon in an amount greater than or equal to 8% to less than or equal to about 10.5%;
magnesium in an amount greater than or equal to about 0.3% to less than or equal to about 0.5%;
iron in an amount greater than or equal to about 0.2% to less than or equal to about 0.25%; and
greater than or equal to about 88% aluminum, and
wherein a composition of the third Al—Si—Mg—Fe alloy is different from that of the first Al—Si—Mg—Fe alloy and from that of the second Al—Si—Mg—Fe alloy.

12. The vehicle of claim 11, wherein the vehicle propulsion system component is manufactured via a high-pressure die casting process.

13. (canceled)

14. The vehicle of claim 11, wherein the third Al—Si—Mg—Fe alloy further comprises a casting agent, and wherein the casting agent comprises, by mass:
(i) chromium in an amount greater than or equal to about 0.2% to less than or equal to about 0.3% and manganese in an amount less than or equal to about 0.1%, or
(ii) manganese in an amount greater than or equal to about 0.2% to less than or equal to about 0.3% and strontium in an amount greater than or equal to about 300 parts per million to less than or equal to about 500 parts per million.

15. The vehicle of claim 11, wherein the vehicle propulsion system component is a motor housing, transmission case, battery housing, electrical inverter housing, electronic control module housing, or a combination thereof.

16. A vehicle including recyclable cast aluminum alloy components, the recyclable cast aluminum alloy components comprising:
(i) a vehicle body component, wherein the vehicle body component is cast via a high-pressure die casting process from a first Al—Si—Mg—Fe alloy that comprises, by mass:
silicon in an amount greater than or equal to 8% and less than or equal to about 9.5%;
magnesium in an amount less than or equal to 0.15%;
iron in an amount greater than or equal to about 0.15% to less than or equal to about 0.25%; and
greater than or equal to about 89% aluminum; and
(ii) a vehicle chassis component, wherein, the vehicle chassis component is cast from a second Al—Si—Mg—Fe alloy that comprises, by mass:
silicon in an amount greater than or equal to about 6.5% to less than or equal to 7.5%;
magnesium in an amount greater than or equal to about 0.25% to less than or equal to about 0.4%;
iron in an amount greater than or equal to about 0.15% to less than or equal to about 0.25%; and
greater than or equal to about 91% aluminum,
wherein the composition of the first Al—Si—Mg—Fe alloy is different from that of the second Al—Si—Mg—Fe alloy.

17. The vehicle of claim 16, wherein the first Al—Si—Mg—Fe alloy further comprises a casting agent, and wherein the casting agent comprises, by mass:
(i) chromium in an amount greater than or equal to about 0.15% to less than or equal to about 0.3% and manganese in an amount less than 0.15%, or
(ii) manganese in an amount greater than or equal to about 0.2% to less than or equal to about 0.3% and strontium in an amount greater than or equal to about 300 parts per million to less than or equal to about 500 parts per million.

18. The vehicle of claim 16, wherein the second Al—Si—Mg—Fe alloy further comprises a casting agent, and wherein the casting agent comprises, by mass:
(i) chromium in an amount greater than or equal to about 0.1% to less than or equal to about 0.2% and manganese in an amount less than 0.15%, or
(ii) manganese in an amount greater than or equal to about 0.2% to less than or equal to about 0.3% and strontium in an amount greater than or equal to about 100 parts per million to less than or equal to about 200 parts per million.

19. The vehicle of claim 16, wherein the recyclable cast aluminum alloy components further comprise a vehicle propulsion system component cast via a high-pressure die casting process from a third Al—Si—Mg—Fe alloy that comprises, by mass:
silicon in an amount greater than or equal to 8% to less than or equal to about 10.5%;
magnesium in an amount greater than or equal to about 0.3% to less than or equal to about 0.5%;
iron in an amount greater than or equal to about 0.2% to less than or equal to about 0.25%;
a casting agent comprising, by mass:
(i) chromium in an amount greater than or equal to about 0.2% to less than or equal to about 0.3% and manganese in an amount less than or equal to about 0.1%, or
(ii) manganese in an amount greater than or equal to about 0.2% to less than or equal to about 0.3% and strontium in an amount greater than or equal to about 300 parts per million to less than or equal to about 500 parts per million; and
greater than or equal to about 88% aluminum
wherein a composition of the third Al—Si—Mg—Fe alloy is different from that of the first Al—Si—Mg—Fe alloy and from that of the second Al—Si—Mg—Fe alloy.

20. A method of manufacturing a recycled aluminum alloy component, the method comprising:
melting the recyclable cast aluminum alloy components of claim 16 to form an aluminum alloy melt comprising, by mass:
silicon in an amount greater than or equal to about 6% to less than or equal to about 11%,
magnesium in an amount less than or equal to about 0.5%,
iron in an amount greater than or equal to about 0.15% to less than or equal to about 0.25%,
manganese in an amount less than or equal to about 0.3%, and
greater than or equal to about 88% aluminum; and
casting a volume of the aluminum alloy melt into a desired shaped via a high-pressure die casting process, a permanent mold casting process, or a semi-permanent mold casting process to form a recycled vehicle body component, a recycled vehicle chassis component, or a recycled vehicle propulsion system component,
wherein the recyclable cast aluminum alloy components account for, by mass, greater than or equal to about 70% of the recycled aluminum alloy component.

21. The vehicle of claim 1, wherein the vehicle body component has a wall thickness of greater than or equal to about 0.5 millimeters to less than about 5 millimeters, and wherein the vehicle chassis component has a wall thickness of greater than 5 millimeters to less than or equal to about 10 millimeters.

22. The vehicle of claim 11, wherein the vehicle body component has a wall thickness of greater than or equal to about 0.5 millimeters to less than about 5 millimeters, the vehicle chassis component has a wall thickness of greater than 5 millimeters to less than or equal to about 10 millimeters, and wherein the vehicle propulsion system component has a wall thickness of greater than or equal to about 0.5 millimeters to less than about 5 millimeters.

23. The vehicle of claim 1, wherein the vehicle comprises greater than or equal to about 100 kilograms of the recyclable cast aluminum alloy components, the vehicle body component accounts for, by mass, greater than or equal to about 5% to less than or equal to about 60% of the recyclable cast aluminum alloy components, and the vehicle chassis component accounts for, by mass, greater than or equal to about 10% to less than or equal to about 80% of the recyclable cast aluminum alloy components.
